(19) United States
(12) Patent Application Publication
(10) Pub. No.: US 2026/0146800 A1
(43) Pub. Date: May 28, 2026

(54) SYSTEM INCLUDING METAL HYDRIDES FOR WASTE HEAT PROCESSING AND RECOVERY

(71) Applicant: BATTELLE SAVANNAH RIVER ALLIANCE, LLC, AIKEN, SC (US)

(72) Inventors: PATRICK A. WARD, AIKEN, SC (US); SIMONA E. HUNYADI MURPH, NORTH AUGUSTA, SC (US)

(21) Appl. No.: 18/959,955

(22) Filed: Nov. 26, 2024

(51) Int. Cl. F28D 20/00; F28D 21/00

(52) U.S. Cl. CPC F28D 20/003; F28D 21/0001; F28D 2020/0017

(57) ABSTRACT

The present disclosure is directed to a system and method including a high temperature metal hydride and a low temperature metal hydride. The system may include a heating bed comprising an inorganic composition. Notably, the inorganic composition may be water reactive. The system and method may be used to process waste heat.

### FEDERAL RESEARCH STATEMENT

This invention was made with government support under Contract No. 89303321CEM000080 awarded by the U.S. Department of Energy. The government has certain rights in the invention.

### BACKGROUND OF THE INVENTION

In recent years, corporate sustainability initiatives and national environmental initiatives have become increasingly prominent and influential. Notably, the waste management of manufacturing processes has become a growing concern as manufacturers adjust their processes to better respond to environmental concerns of the manufacturer itself, the public, and administrative or governmental entities.

Consequently, the processing and recovery of waste heat has been studied and various systems have been created to process waste heat. However, the components, materials, and systems utilized to process waste heat are exceptionally wide-ranging. As such, it remains to be ascertained which components and materials may be beneficial in processing and recovering waste heat.

As a result, there is a need to provide an improved system for waste heat processing and recovery. In particular, a need exists for a high efficiency heat pump system comprising metal hydrides, the system being capable of returning thermal energy at a higher temperature than the temperature of the waste heat that the system originally received.

### SUMMARY OF THE INVENTION

Aspects and advantages of the invention will be set forth in part in the following description, or may be obvious from the description, or may be learned through practice of the invention.

In accordance with one aspect of the present invention, a system is disclosed. The system may comprise: a high temperature metal hydride, the high temperature metal hydride being positioned within a high temperature metal hydride container; a low temperature metal hydride, the low temperature metal hydride being positioned within a low temperature metal hydride container, the low temperature metal hydride container being in fluid communication with the high temperature metal hydride container; and a heating bed, the heating bed being in thermal communication with low temperature metal hydride, the heating bed comprising an inorganic composition, the inorganic composition being water reactive.

In accordance with one aspect of the present invention, a system is disclosed. The system may comprise: a high temperature metal hydride, the high temperature metal hydride being positioned within a high temperature metal hydride container; a low temperature metal hydride, the low temperature metal hydride being positioned within a low temperature metal hydride container, the low temperature metal hydride container being in fluid communication with the high temperature metal hydride container; and a heating bed, the heating bed being in thermal communication with the low temperature metal hydride, the heating bed comprising an inorganic composition, the inorganic composition comprising a metal hydroxide or a zeolite.

In accordance with one aspect of the present invention, a process is disclosed. The process may comprise: charging a system, the system comprising: a high temperature metal hydride, the high temperature metal hydride being positioned within a high temperature metal hydride container; a low temperature metal hydride, the low temperature metal hydride being positioned within a low temperature metal hydride container, the low temperature metal hydride container being in fluid communication with the high temperature metal hydride container; and a heating bed, the heating bed being in thermal communication with low temperature metal hydride, the heating bed comprising an inorganic composition, the inorganic composition being water reactive; and discharging the system.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a system for processing and recovering waste heat in accordance with aspects of the present subject matter;

FIG. 2 illustrates a system for processing and recovering waste heat in a charging state in accordance with aspects of the present subject matter;

FIG. 3 illustrates a system for processing and recovering waste heat in a discharging state in accordance with aspects of the present subject matter;

FIG. 4 illustrates a system for processing and recovering waste heat in accordance with aspects of the present subject matter; and

FIG. 5 illustrates a system for processing and recovering waste heat in a discharging state in accordance with aspects of the present subject matter.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a system and a method of processing and recovering waste heat. In particular, the system and/or method may include a low temperature metal hydride, a high temperature metal hydride, and a heating bed. The present inventors have discovered that the system disclosed herein can have various benefits due to the use of the low temperature metal hydride, the high temperature metal hydride, and the heating bed. Particularly, the present inventors have discovered that a system formed in accordance with the present disclosure may discharge or produce thermal energy that has a higher temperature than the waste heat originally received by the system. Notably, the waste heat may originate from various processes or industries, including metal ore refineries, steel manufacturers, or concrete manufacturers.

Generally, processed thermal energy produced by the system may be directed or transferred to a thermal energy storage device or back into a process, such as the process from which the waste heat originated. In some aspects, processed thermal energy produced by the system may be directed or transferred to a Stirling engine. Notably, the Stirling engine may generate electricity from the processed thermal energy.

It should be understood that throughout the entirety of this specification, each numerical value (e.g., temperature, enthalpy) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that, unless stated otherwise, any standard listed herein (e.g., ASTM) is the most recent version available as of the latest revision year. Notably, some aspects of the present disclosure may omit one or more of the features disclosed herein. Further, it should be understood that the use of a heat exchanger as disclosed herein may include the use of one or more heat transfer fluids in the heat exchanger.

As previously disclosed herein, a system formed in accordance with the present disclosure may include a high temperature metal hydride. As used herein, a “high temperature metal hydride” refers to a metal hydride that adsorbs and/or releases hydrogen at high temperatures, such as a temperature of about 200° C. or more. Generally, the high temperature metal hydride may be a titanium alloy comprised of a combination of titanium with vanadium, aluminum, iron, chromium, and/or manganese. In some aspects, the high temperature metal hydride may be a calcium aluminum alloy, a calcium aluminum silicon alloy, magnesium hydride, magnesium iron hydride, sodium aluminum hydride, or any combination or alloy thereof. The high temperature metal hydride may be in the form of a bed. In this respect, a system formed in accordance with the present disclosure may include a high temperature metal hydride bed. Notably, a high temperature metal hydride bed may be a fixed bed or a packed bed. In the case of a titanium based high temperature metal hydride bed, the bed may be formed via 3D printing, such as electron beam 3D printing or laser 3D printing. The use of dual head printing techniques can allow for the 3D printing of the containment vessel and heat exchanger from a stainless steel or Inconel alloy and a titanium based alloy bed simultaneously. Notably, a closed system as disclosed herein (e.g., a first closed system) may be formed via 3D printing. Generally, any of the components (e.g., a metal hydride container, a metal hydride, a heat exchanger) of a system disclosed herein may be formed via 3D printing.

Generally, the high temperature metal hydride may have an adsorption enthalpy from about 30 kJ/mol to about 180 kJ/mol, including all increments of 1 kJ/mol therebetween. In general, the high temperature metal hydride may have an adsorption enthalpy of about 30 kJ/mol or more, such as about 40 kJ/mol or more, such as about 60 kJ/mol or more, such as about 80 kJ/mol or more, such as about 100 kJ/mol or more, such as about 120 kJ/mol or more, such as about 140 kJ/mol or more, such as about 160 kJ/mol or more. The high temperature metal hydride may have an adsorption enthalpy of about 180 kJ/mol or less, such as about 160 kJ/mol or less, such as about 140 kJ/mol or less, such as about 120 kJ/mol or less, such as about 100 kJ/mol or less, such as about 80 kJ/mol or less, such as about 60 kJ/mol or less, such as about 40 kJ/mol or less. Notably, the adsorption enthalpy of the high temperature metal hydride may affect the thermal energy density of the system and the operational temperatures of the system. Generally, the rate of hydrogen uptake may influence the temperature upgrading capacity and the efficiency of the system.

In general, a high temperature metal hydride bed may have a volume of about 1 m³ or less, such as about 0.8 m³ or less, such as about 0.6 m³ or less, such as about 0.4 m³ or less, such as about 0.2 m³ or less. In some aspects, a high temperature metal hydride bed may have a volume of about 0.01 m³ or more, such as about 0.05 m³ or more, such as about 0.1 m³ or more, such as about 0.2 m³ or more, such as about 0.4 m³ or more, such as about 0.6 m³ or more, such as about 0.8 m³ or more.

Generally, the high temperature metal hydride may be positioned in a container (e.g., a tank), which may be referred to herein as a high temperature metal hydride container. The container may be formed from a metal. For instance, the metal may be an alloy (e.g., stainless steel, aluminum alloy, titanium alloy). Notably, the container and/or high temperature metal hydride may be in thermal communication with a waste heat source, such as a manufacturing process. The waste heat source may transfer thermal energy to the high temperature metal hydride and/or the high temperature metal hydride container via a heat exchanger, a heat transfer fluid, or direct conduction. Notably, a heat exchanger may allow for more controlled or maintained thermal energy transfer from a waste heat source to a high temperature metal hydride.

In general, the high temperature metal hydride and/or the high temperature metal hydride container may be in thermal communication with one or more heat exchangers. For instance, a heat exchanger may allow for the transfer of thermal energy from waste heat to the high temperature metal hydride. Further, a heat exchanger may allow for the transfer of thermal energy from the high temperature metal hydride to a thermal energy storage device or back into a process, such as the process from which the waste heat originated.

In some aspects, the waste heat source may provide waste heat to a heat exchanger, a high temperature metal hydride, and/or a high temperature metal hydride container, the waste heat having a temperature from about 100° C. to about 750° C., including all increments of 1° C. therebetween. Generally, the waste heat source may provide waste heat having a temperature of about 100° C. or more, such as about 200° C. or more, such as about 250° C. or more, such as about 300° C. or more, such as about 350° C. or more, such as about 400° C. or more, such as about 450° C. or more, such as about 500° C. or more, such as about 600° C. or more. The waste heat source may provide waste heat having a temperature of about 750° C. or less, such as about 700° C. or less, such as about 600° C. or less, such as about 500° C. or less, such as about 450° C. or less, such as about 400° C. or less, such as about 350° C. or less, such as about 300° C. or less, such as about 250° C. or less, such as about 200° C. or less.

As previously disclosed herein, a system formed in accordance with the present disclosure may include a low temperature metal hydride. As used herein, a “low temperature metal hydride” refers to a metal hydride that adsorbs and/or releases hydrogen at low temperatures, such as a temperature of about 200° C. or less. Generally, the low temperature metal hydride may be an AB₂ or AB₅ hydride such as titanium iron, titanium iron manganese, lanthanum nickel, lanthanum aluminum nickel, titanium chromium, vanadium hydride, palladium hydride, or any combination or alloy thereof. Notably, an AB₂ or AB₅ hydride may include an “A” that is a transition metal or a rare-earth metal and a “B” that is a transition metal. In general, a transitional metal may be any transition metal and a rare-earth metal may be any rare-earth metal. The low temperature metal hydride may be in the form of a bed. In this respect, a system formed in accordance with the present disclosure may include a low temperature metal hydride bed. Notably, a low temperature metal hydride bed may be a fixed bed or a packed bed. In general, a low temperature metal hydride bed may be formed via 3D printing, such as electron beam 3D printing or laser 3D printing.

Notably, the adsorption enthalpy of the low temperature metal hydride may be less than the adsorption enthalpy of the high temperature metal hydride. Generally, the low temperature metal hydride may have an adsorption enthalpy from about 5 kJ/mol to about 60 kJ/mol, including all increments of 1 kJ/mol therebetween. In general, the low temperature metal hydride may have an adsorption enthalpy of about 10 kJ/mol or more, such as about 20 kJ/mol or more, such as about 30 kJ/mol or more, such as about 40 kJ/mol or more, such as about 50 kJ/mol or more. The low temperature metal hydride may have an adsorption enthalpy of about 60 kJ/mol or less, such as about 50 kJ/mol or less, such as about 40 kJ/mol or less, such as about 30 kJ/mol or less, such as about 10 kJ/mol or less. Notably, the adsorption enthalpy of the low temperature metal hydride may affect the operational temperature of the system and the overall volume of the system.

In general, a low temperature metal hydride bed may have a volume of about 1 m³ or less, such as about 0.8 m³ or less, such as about 0.6 m³ or less, such as about 0.4 m³ or less, such as about 0.2 m³ or less. In some aspects, a low temperature metal hydride bed may have a volume of about 0.01 m³ or more, such as about 0.05 m³ or more, such as about 0.1 m³ or more, such as about 0.2 m³ or more, such as about 0.4 m³ or more, such as about 0.6 m³ or more, such as about 0.8 m³ or more.

Generally, the low temperature metal hydride may be positioned in a container (e.g., a tank), which may be referred to herein as a low temperature metal hydride container. The container may be formed from a metal. For instance, the metal may be an alloy (e.g., stainless steel, aluminum alloy, nickel alloy, titanium alloy). Notably, the container and/or low temperature metal hydride may be in thermal communication with a heating bed. As used herein, a “heating bed” refers to a material that is capable of transferring thermal energy to the low temperature metal hydride and/or a low temperature metal hydride container. The low temperature metal hydride may transfer thermal energy to the heating bed via a heat exchanger or direct conduction. Further, the heating bed may transfer thermal energy to the low temperature metal hydride and/or the low temperature metal hydride container via a heat exchanger or direct conduction.

Generally, a high temperature metal hydride and/or a low temperature metal hydride may degrade over time. In this respect, the high temperature metal hydride and/or the low temperature metal hydride of a system may be replaced and/or annealed. In general, the high temperature metal hydride and/or the low temperature metal hydride may be replaced before, after, and/or during one or more of any of the steps disclosed herein.

As previously disclosed herein, a system formed in accordance with the present disclosure may include a heating bed. Generally, the heating bed may be in thermal communication with the low temperature metal hydride or a container containing the low temperature metal hydride. In general, the heating bed may include an inorganic composition. As used herein, “inorganic composition” refers to a composition that does not contain carbon. Generally, the inorganic composition may include an aluminosilicate (e.g., zeolite), a hydroxide, or a combination thereof. In some aspects, the hydroxide may be a metal hydroxide such as aluminum hydroxide, barium hydroxide, calcium hydroxide, iron hydroxide (e.g., iron(III) hydroxide), lithium hydroxide, magnesium hydroxide, potassium hydroxide, sodium hydroxide, strontium hydroxide, zinc hydroxide, or a combination thereof. In some aspects, the inorganic composition (e.g., a metal hydroxide) may be substantially insoluble in water. Notably, the inorganic composition may be water-reactive. In this respect, the inorganic composition may react with water or a gas containing water (e.g., humid gas), such as in an exothermic reaction. Notably, thermal energy provided by a low temperature metal hydride and/or a low temperature metal hydride container to the heating bed may result in water desorption from the heating bed and/or the inorganic composition.

Generally, the heating bed may be positioned in a container (e.g., a tank), which may be referred to herein as a heating bed container. The container may be formed from a metal. For instance, the metal may be an alloy (e.g., stainless steel, aluminum alloy, nickel alloy, titanium alloy). In general, a heating bed container may have a heating bed container inlet and a heating bed container outlet. The heating bed container inlet may transport or allow for the introduction of an exothermic additive into the heating bed container, such as via an exothermic additive inlet stream. The heating bed container outlet may transport or allow for the exit of an exothermic additive from the heating bed container, such as via an exothermic additive outlet stream. As used herein, an “exothermic additive” refers to an additive that reacts with the inorganic composition of the heating bed to produce an exothermic reaction. The exothermic additive may be a liquid, a gas, or a dispersion. As used herein, a “dispersion” refers to a liquid having solid particles dispersed therein. In some aspects, the exothermic additive may be a humid gas, humidified air, liquid water, or a combination thereof. Notably, an exothermic additive may be removed from the heating bed via evaporation or a pressurized gas (e.g., air, an inert gas).

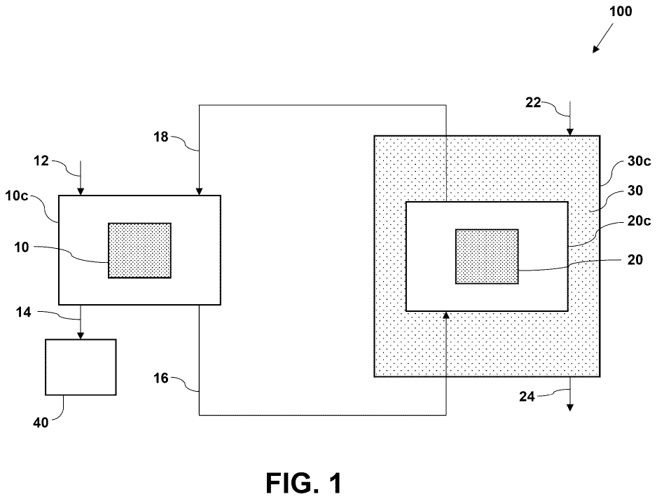

Referring now to FIG. 1, FIG. 1 illustrates a system 100 for processing and recovering waste heat 100 formed in accordance with the present disclosure. Notably, FIG. 1 illustrates a high temperature metal hydride 10, a low temperature metal hydride 20, a heating bed 30, and a thermal energy storage device 40. Additionally, FIG. 1 illustrates a high temperature metal hydride container 10c, a low temperature metal hydride container 20c, and a heating bed container 30c. FIG. 1 further illustrates waste heat 12, processed thermal energy 14, a high temperature metal hydride transfer gas stream 16, a low temperature metal hydride transfer gas 18, an exothermic additive inlet stream 22, and an exothermic additive outlet stream 24.

In general, the high temperature metal hydride 10, the high temperature metal hydride container 10c, the low temperature metal hydride 20, and the low temperature metal hydride container 20c may be part of a first closed system. As used herein, a “closed system” refers to a system in which matter does not leave or enter the system. In some aspects, the low temperature metal hydride 20, the high temperature metal hydride 10, and the hydrogen originating therefrom may be components of a first closed system. Notably, thermal energy can leave or enter a closed system. In some aspects, one or more of the components disclosed herein, such as any of the components herein, may not be a part of the first closed system. For instance, the heating bed 30 and the thermal energy storage device 40 may not be part of the first closed system. In this respect, there may be no mass transfer between the heating bed 30 and the low temperature metal hydride 20 and/or the low temperature metal hydride container 20c. FIG. 1-3 illustrate aspects in which the heating bed 30 and the thermal energy storage device 40 are not part of the first closed system comprising the high temperature metal hydride 10, the high temperature metal hydride container 10c, the low temperature metal hydride 20, and the low temperature metal hydride container 20c.

Generally, the system 100 of the present disclosure is configured to operate in a charging state and a discharging state.

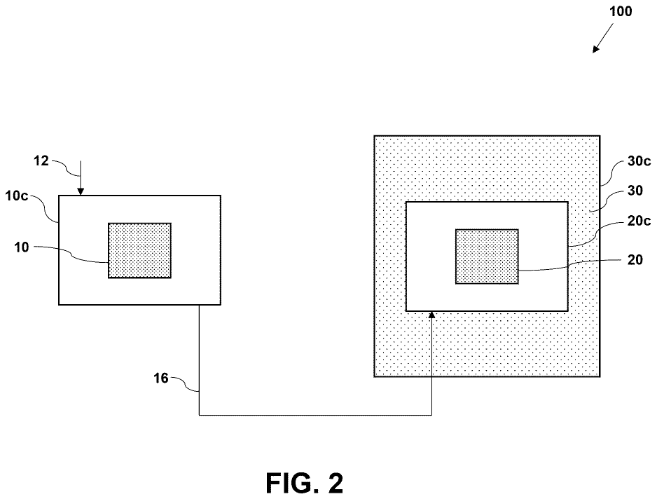

Referring now to FIG. 2, FIG. 2 illustrates one aspect of the charging state of a system 100 for processing and recovering waste heat. As used herein, the “charging state” generally refers to when the high temperature metal hydride bed 10 is receiving thermal energy from the waste heat 12 and hydrogen is transferred to the low temperature metal hydride bed 20. In this respect, the high temperature metal hydride bed 10 stores thermal energy by removing hydrogen endothermically and is, in effect, “charged”. Notably, the heat generated by hydrogen uptake in the low temperature metal hydride bed may remove water from the heating bed. Generally, the high temperature metal hydride container 10c may be in fluid communication with the low temperature metal hydride container 20c. Notably, as illustrated in FIG. 2, a high temperature metal hydride transfer gas stream 16 comprising hydrogen may flow from the high temperature metal hydride container 10c to the low temperature metal hydride container 20c. Generally, the charging state may last for a period of time from 30 seconds to 1 hour, including all increments of 1 second therebetween. For instance, the charging state may last for a period of time of 30 seconds or more, such as 1 minute or more, such as 5 minutes or more, such as 10 minutes or more, such as 15 minutes or more, such as 30 minutes or more. In some aspects, the charging state may last for a period of time of 1 hour or less.

In general, the charging state may begin with the transfer of thermal energy from the waste heat 12 of a waste heat source to the high temperature metal hydride 10 and/or the high temperature metal hydride container 10c. The system 100 may include the transfer of thermal energy from the waste heat 12 to the high temperature metal hydride 10 and/or the high temperature metal hydride container 10c via a heat exchanger, and/or direct conduction. With respect to heat transfer via a heat exchanger, a heat exchanger may transfer thermal energy from the waste heat 12 to the high temperature metal hydride 10. With respect to heat transfer via direct conduction, the waste heat 12 and the high temperature metal hydride 10 may share a container wall, such as the wall of the high temperature metal hydride container 10c, with the waste heat being on one side of the wall and the high temperature metal hydride being on the other side of the wall. Notably, the high temperature metal hydride container 10c, and more particularly the container wall, may allow for the transfer of thermal energy from the waste heat 12 to the high temperature metal hydride 10.

Next, as the high temperature metal hydride 10 absorbs or receives the thermal energy from the waste heat 12, the hydrogen of the high temperature metal hydride 10 may begin to desorb. In this respect, the transfer of thermal energy to the high temperature metal hydride 10 may result in hydrogen desorption from the high temperature metal hydride 10. In general, the hydrogen desorption may increase the pressure inside the high temperature metal hydride container 10c containing the high temperature metal hydride 10. The increase in pressure may result in hydrogen gas flowing from the high temperature metal hydride container 10c containing the high temperature metal hydride 10 to another container, such as a low temperature metal hydride container 20c containing a low temperature metal hydride 20. As illustrated in FIG. 2, a high temperature metal hydride transfer gas stream 16 comprising hydrogen may flow from the high temperature metal hydride container 10c to the low temperature metal hydride container 20c. In some aspects, a compressor or pump may be used to transfer a gas (e.g., hydrogen) between the high temperature metal hydride container 10c and the low temperature metal hydride container 20c.

Then, the hydrogen gas originating from the high temperature metal hydride 10 may be adsorbed by the low temperature metal hydride 20. The adsorption of the hydrogen by the low temperature metal hydride 20 may result in an exothermic reaction that heats the heating bed 30. In this respect, the adsorption of the hydrogen by the low temperature metal hydride 20 may result in the transfer of thermal energy from the low temperature metal hydride 20 and/or the low temperature metal hydride container 20c to the heating bed 30.

Generally, the system 100 may include the transfer of thermal energy from the low temperature metal hydride 20 and/or the low temperature metal hydride container 20c to the heating bed 30 via a heat exchanger and/or direct conduction. With respect to heat transfer via a heat exchanger, a heat exchanger may transfer thermal energy from the low temperature metal hydride 20 and/or the low temperature metal hydride container 20c to the heating bed 30. With respect to heat transfer via direct conduction, the low temperature metal hydride 20 and the heating bed 30 may share a container wall, such as the container wall of the low temperature metal hydride container 20c, with the low temperature metal hydride 20 being on one side of the wall and the heating bed 30 being on the other side of the wall. Notably, as a low temperature metal hydride 20 adsorbs hydrogen, the exothermic reaction may heat the low temperature metal hydride container 20c surrounding the low temperature metal hydride 20. Then, the low temperature metal hydride container 20c, and more particularly the container wall, may transfer thermal energy to the heating bed 30. Generally, a heating bed may be in contact with a low temperature metal hydride container. Notably, a heating bed may surround or enclose a low temperature metal hydride, and more generally may surround or enclose a container containing a low temperature metal hydride. Generally, a container containing a heating bed may contact a container containing a low temperature metal hydride.

Next, the transfer of thermal energy from the low temperature metal hydride 20 and/or the low temperature metal hydride container 20c to the heating bed 30 may result in water desorption from the inorganic composition of the heating bed 30. Notably, water desorption is endothermic. In some aspects, waste heat may be used to assist in the water desorption of the inorganic composition. In this respect, waste heat may be used such that thermal energy from the waste heat is transferred to the heating bed to assist in the water desorption of the inorganic composition. Notably, water may be removed from the heating bed via evaporation or a pressurized gas (e.g., air, an inert gas). In some aspects, humid gas may be removed via a pressurized gas (e.g., air, an inert gas).

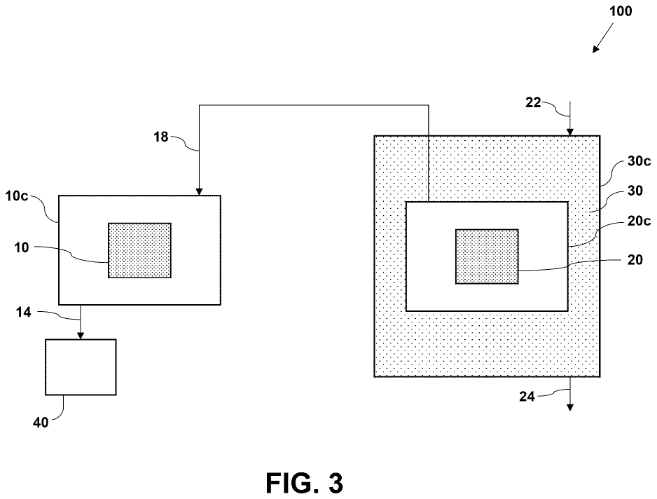

Referring now to FIG. 3, FIG. 3 illustrates one aspect of the discharging state of a system 100 for processing and recovering waste heat. As used herein, the “discharging state” generally refers to when the system 100 is discharging thermal energy to a thermal energy storage device 40 or back into a process, such as the process from which the waste heat 12 originated. Generally, the discharging state may last for a period of time from 30 seconds to 1 hour, including all increments of 1 second therebetween. For instance, the discharging state may last for a period of time 30 seconds or more, such as 1 minute or more, such as 5 minutes or more, such as 10 minutes or more, such as 15 minutes or more, such as 30 minutes or more. In some aspects, the discharging state may last for a period of time of 1 hour or less.

In general, the discharging state may begin with the introduction of an exothermic additive via an exothermic additive inlet stream 22 into the system 100 and/or the heating bed container 30c. In general, the exothermic additive may contact the heating bed 30. The exothermic additive may contact and chemically react with the inorganic composition of the heating bed 30 and produce an exothermic reaction. The exothermic additive may exit the system 100 and/or the heating bed container 30c via an exothermic additive outlet stream 24.

In general, the exothermic additive inlet stream 22 may comprise any of the exothermic additives disclosed herein. Notably, the exothermic additive may be water and/or humid gas. The exothermic reaction produced by the exothermic additive and the inorganic composition may result in the transfer of thermal energy from the heating bed 30 to the low temperature metal hydride 20 and/or the low temperature metal hydride container 20c. For instance, the system 100 may include the transfer of thermal energy from the heating bed 30 to the low temperature metal hydride 20 and/or the low temperature metal hydride container 20c via a heat exchanger and/or direct conduction. With respect to heat transfer via a heat exchanger, a heat exchanger may transfer thermal energy from the heating bed 30 to the low temperature metal hydride 20 and/or the low temperature metal hydride container 20c. With respect to heat transfer via direct conduction, the heating bed 30 and the low temperature metal hydride 20 may share a container wall, such as the container wall of the low temperature metal hydride container 20c, with the heating bed 30 being on one side of the wall and the low temperature metal hydride 20 being on the other side of the wall. Notably, the low temperature metal hydride container 20c, and more particularly the container wall of the low temperature metal hydride container 20c, may allow for the transfer of thermal energy from the heating bed 30 to the low temperature metal hydride 20.

Next, as the low temperature metal hydride 20 absorbs or receives the thermal energy from the heating bed 30, the hydrogen of the low temperature metal hydride 20 may begin to desorb. In this respect, the transfer of thermal energy to the low temperature metal hydride 20 may result in hydrogen desorption of the low temperature metal hydride 20. In general, the hydrogen desorption may increase the pressure inside the low temperature metal hydride container 20c containing the low temperature metal hydride 20. The increase in pressure may result in the hydrogen gas flowing from the low temperature metal hydride container 20c containing the low temperature metal hydride 20 to another container, such as the high temperature metal hydride container 10c containing the high temperature metal hydride 10. It should be understood that the low temperature metal hydride container 20c may be in fluid communication with the high temperature metal hydride container 10c. In general, the pressure may be allowed to increase to a peak pressure before allowing the gas to flow to the high temperature metal hydride bed 10. Notably, as illustrated in FIG. 3, a low temperature metal hydride transfer gas stream 18 comprising hydrogen may flow from the low temperature metal hydride container 20c to the high temperature metal hydride container 10c. In some aspects, a compressor or pump may be used to transfer a gas (e.g., hydrogen) between the low temperature metal hydride container 20c and the high temperature metal hydride container 10c.

Then, the hydrogen gas originating from the low temperature metal hydride 20 may be adsorbed by the high temperature metal hydride 10. Notably, a compressor or pump may generate higher pressures which may accelerate the reaction or adsorption of hydrogen gas by the high temperature metal hydride 10. The adsorption of the hydrogen by the high temperature metal hydride 10 may result in a strong exothermic reaction. In this respect, the adsorption of the hydrogen by the high temperature metal hydride 10 may result in the transfer of processed thermal energy 14 from the high temperature metal hydride 10 to a thermal energy storage device 40 or back into a process, such as the process from which the waste heat 12 originated. Notably, the processed thermal energy 14 may have a higher temperature than the temperature of the waste heat 12. Generally, the system 100 may include the transfer of processed thermal energy 14 from the high temperature metal hydride 10 to the thermal energy storage device 40 or back into a process via a heat exchanger and/or direct conduction. With respect to heat transfer via a heat exchanger, a heat exchanger may transfer processed thermal energy 14 from the high temperature metal hydride 10 to the thermal energy storage device 40 or back into a process, such as the process from which the waste heat 12 originated. With respect to heat transfer via direct conduction, the high temperature metal hydride 10 and the thermal energy storage device 40 may share the container wall of the high temperature metal hydride container 10c, with the high temperature metal hydride 10 being on one side of the wall and the thermal energy storage device 40 being on the other side of the wall. Notably, the high temperature metal hydride container 10c, and more particularly the container wall of the high temperature metal hydride container 10c, may allow for the transfer of processed thermal energy 14 from the high temperature metal hydride 10 to the thermal energy storage device 40.

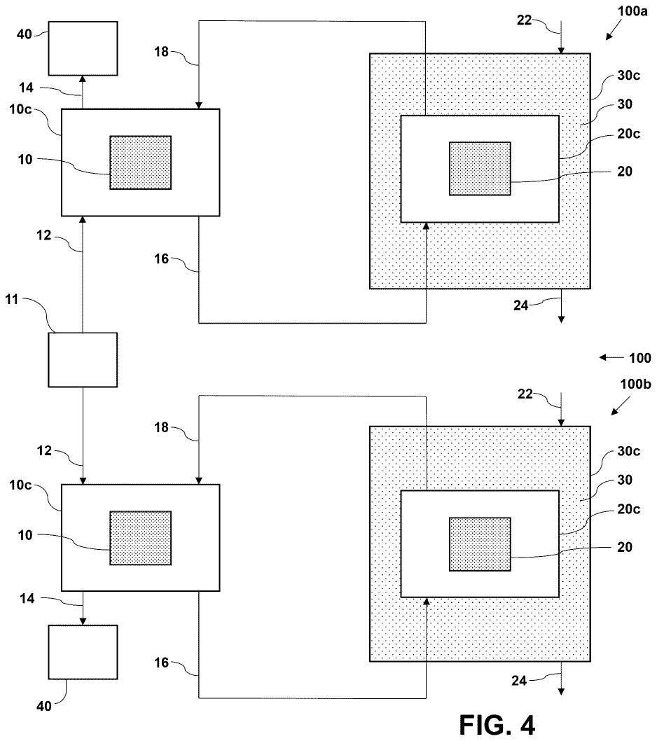

In some aspects, a system formed in accordance with the present disclosure may include two or more of any of the components (e.g., two or more low temperature metal hydrides, two or more high temperature metal hydrides, two or more heating beds, etc.) disclosed herein. For instance, as illustrated in FIG. 4, a system 100 formed in accordance with the present disclosure may include parallel subsystems 100a, 100b. Notably, a waste heat source 11 may provide waste heat 12 to two or more subsystems, such as the two subsystems 100a, 100b illustrated in FIG. 4. The use of two or more subsystems may allow one subsystem to be in a charging state while the other subsystem is in a discharging state. Notably, this may allow for the advantageous, continuous processing of waste heat to provide a continuous processed thermal energy. It should be understood that a subsystem formed in accordance with the present disclosure may include any of the components, properties, characteristics, materials, etc. of a system as disclosed herein.

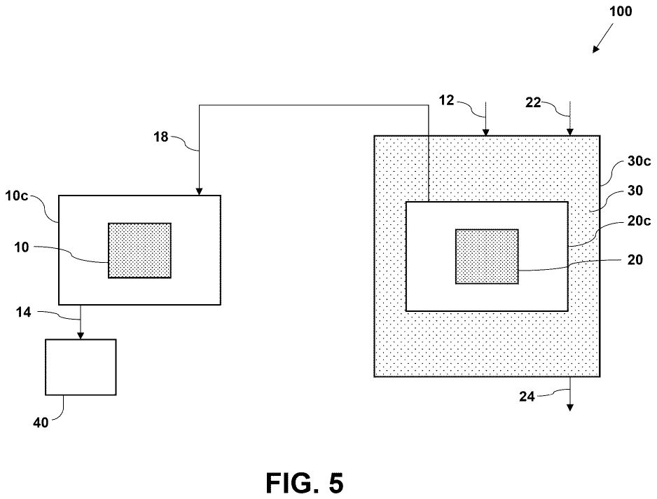

Referring now to FIG. 5, FIG. 5, illustrates one aspect of the discharging state of a system 100 for processing and recovering waste heat. Notably, FIG. 5 illustrates that waste heat 12 may be transferred to the heating bed 30 to expedite the removal of water from the heating bed 30.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A system comprising:
a high temperature metal hydride, the high temperature metal hydride being positioned within a high temperature metal hydride container;
a low temperature metal hydride, the low temperature metal hydride being positioned within a low temperature metal hydride container, the low temperature metal hydride container being in fluid communication with the high temperature metal hydride container; and
a heating bed, the heating bed being in thermal communication with low temperature metal hydride, the heating bed comprising an inorganic composition, the inorganic composition being water reactive.

2. The system of claim 1, wherein the system further comprises an exothermic additive inlet stream comprising an exothermic additive.

3. The system of claim 2, wherein the exothermic additive comprises water.

4. The system of claim 2, wherein the exothermic additive is humid gas.

5. The system of claim 1, wherein the system further comprises an exothermic additive outlet stream.

6. The system of claim 1, wherein the system further comprises a waste heat source, the waste heat source being in thermal communication with the high temperature metal hydride.

7. The system of claim 1, wherein the high temperature metal hydride has an adsorption enthalpy of from about 30 kJ/mol to about 180 kJ/mol.

8. The system of claim 1, wherein the low temperature metal hydride has an adsorption enthalpy of from about 5 kJ/mol to about 60 kJ/mol.

9. The system of claim 1, wherein the inorganic composition is substantially water-insoluble.

10. The system of claim 1, wherein the high temperature metal hydride and the low temperature metal hydride are components of a closed system, the closed system not comprising the heating bed.

11. The system of claim 1, wherein the system is configured to operate in a charging state and a discharging state, wherein the charging state includes a transfer of hydrogen gas from the high temperature metal hydride container to the low temperature metal hydride container and the discharging state includes the transfer of hydrogen gas from the low temperature metal hydride container to the high temperature metal hydride container.

12. The system of claim 1, wherein the heating bed is positioned in a heating bed container, wherein the system is configured to operate in a charging state and a discharging state, wherein the discharging state includes adding an exothermic additive to the heating bed container, the addition of the exothermic additive resulting in an exothermic reaction between the inorganic composition of the heating bed and the exothermic additive.

13. The system of claim 12, wherein the exothermic reaction between the inorganic composition and the exothermic additive results in the transfer of thermal energy to the low temperature metal hydride, wherein the transfer of thermal energy to the low temperature metal hydride results in a desorption of hydrogen from the low temperature metal hydride.

14. The system of claim 1, wherein the high temperature metal hydride, the high temperature metal hydride container, the low temperature metal hydride, the low temperature metal hydride container, or a combination thereof are formed via 3D printing.

15. A system comprising:
a high temperature metal hydride, the high temperature metal hydride being positioned within a high temperature metal hydride container;
a low temperature metal hydride, the low temperature metal hydride being positioned within a low temperature metal hydride container, the low temperature metal hydride container being in fluid communication with the high temperature metal hydride container; and
a heating bed, the heating bed being in thermal communication with the low temperature metal hydride, the heating bed comprising an inorganic composition, the inorganic composition comprising a metal hydroxide.

16. The system of claim 15, wherein the system further comprises an exothermic additive inlet stream comprising an exothermic additive.

17. The system of claim 16, wherein the exothermic additive comprises water.

18. The system of claim 15, wherein the high temperature metal hydride and the low temperature metal hydride are components of a closed system, the closed system not comprising the heating bed.

19. A process comprising:
charging a system, the system comprising:
a high temperature metal hydride, the high temperature metal hydride being positioned within a high temperature metal hydride container;
a low temperature metal hydride, the low temperature metal hydride being positioned within a low temperature metal hydride container, the low temperature metal hydride container being in fluid communication with the high temperature metal hydride container; and
a heating bed, the heating bed being in thermal communication with low temperature metal hydride, the heating bed comprising an inorganic composition, the inorganic composition being water reactive; and
discharging the system.

20. The process of claim 19, wherein charging the system comprises:
transferring thermal energy to the high temperature metal hydride, the transfer of thermal energy to the high temperature metal hydride resulting in a desorption of hydrogen gas from the high temperature metal hydride;
transferring the hydrogen gas to the low temperature metal hydride container, the low temperature metal hydride adsorbing the hydrogen gas; and
transferring thermal energy from the low temperature metal hydride to the heating bed.

21. The process of claim 19, wherein discharging the system comprises:
contacting an exothermic additive with the heating bed, the contact of the exothermic additive and the heating bed resulting in an exothermic reaction between the inorganic composition of the heating bed and the exothermic additive;
transferring thermal energy from the heating bed to the low temperature metal hydride, the transfer of thermal energy to the low temperature metal hydride resulting in a desorption of hydrogen gas from the low temperature metal hydride; and
transferring the hydrogen gas to the high temperature metal hydride container, the high temperature metal hydride adsorbing the hydrogen gas.
